(19) United States
(12) Patent Application Publication
(10) Pub. No.: US 2015/0049375 A1
(43) Pub. Date: Feb. 19, 2015

(54) COMPACT BEAM DIRECTOR

(71) Applicant: Optical Physics Company, Calabasas, CA (US)

(72) Inventor: Richard A. HUTCHIN, Reno, NV (US)

(73) Assignee: Optical Physics Company, Calabasas, CA (US)

(21) Appl. No.: 13/968,888

(22) Filed: Aug. 16, 2013

(51) Int. Cl. G02B 26/08

(52) U.S. Cl. CPC G02B 26/0816; G02B 26/0875; G02B 26/0825
USPC 359/221.3; 359/226.1

(57) ABSTRACT

A beam director includes first and second refractive elements, a reflective surface, and a platform. The reflective surface and the second refractive element are mechanically and optically coupled, and the first refractive element is optically coupled to the second refractive element through the reflective surface. The platform is configured to rotate the reflective surface and the second refractive surface about the optical axis of the first refractive element while maintaining the optical couplings.

### BACKGROUND OF THE INVENTION

1. Field of the Invention

The field of the present invention relates to optical beam control systems, in particular to beam directors.

2. Background

Many optical beam control systems require mechanisms for steering and directing incoming and/or outgoing light over a wide operational field of view.

Currently many optical beam control systems use turrets as beam directors. Turrets can be used to steer incoming light. One example is a ball turret camera assembly, such as the TASE400 from UTC Aerospace Systems. This turret is smaller than a cubic foot and weighs about 8 pounds. Turrets can also be used to steer outgoing light. One example is the Airborne Laser (ABL) laser turret mounted on the nose of a Boeing 747-400F aircraft. This turret is a large structure with a complex design. It measures 183 meters in diameter and weighs 12 to 15 thousand pounds.

Multi axis turrets can aim in azimuth and elevation. Multi axis turrets around 30″ in diameter have been integrated on the side of helicopters. One such gimbaled turret (AIRS from Southern Research Institute) has a four axis gimbal that provides +/−110 degrees of azimuth and +/−110 degrees of roll.

One common feature of currently available turrets is that their inner diameters have to be large enough to accommodate the folding of light inside the turret dome. This requires a volume that envelops approximately three times the beam diameter on each side. Consequently, a beam diameter (d) requires a significantly larger turret dome diameter (approximately 3d). A beam director that can offer a large field of regard within a compact volume is therefore highly desirable.

### SUMMARY OF THE INVENTION

The present invention is directed toward abeam director which employs two refractive elements with a reflective surface optically coupled therebetween, such that the reflective surface and one of the refractive elements are rotatable around the optical axis of the other refractive element.

The beam director includes a first refractive element, a reflective surface, and a second refractive element, which is optically and mechanically coupled to the reflective surface and optically coupled to the first refractive element through the reflective surface. A platform is configured to rotate the reflective surface and the second refractive element around the optical axis of the first refractive element while maintaining the optical couplings. Such a compact beam director may be used with both incoming and outgoing beams, and it may be used with single beam lasers or with multi-beam lasers.

Accordingly, a beam director is disclosed. Additional advantages of the improvements will appear from the drawings and the description of the preferred embodiment.

### BRIEF DESCRIPTION OF THE DRAWINGS

In the drawings, wherein like reference numerals refer to similar components:

FIG. 1A and FIG. 1B schematically illustrate a beam director;

FIG. 2A is a partial sectional view of abeam director;

FIG. 2B is a schematic view of the beam path through the beam director of FIG. 2A;

FIG. 2C is a side schematic view of the beam path through the beam director of FIG. 2A;

FIG. 2D a front schematic view of the beam path through the beam director of FIG. 2A;

FIG. 2E. illustrates a side view of a ray trace of h beam through the beam director of FIG. 2A;

FIG. 2F illustrates a front view of a ray trace of the bean through the beam director of FIG. 2A;

FIGS. 3A-B illustrate deployed and stowed views of a second beam director;

FIG. 4A is a partial sectional view of a third beam director with embedded adaptive optics components; and

FIG. 4B illustrates a part of the beam path of the beam director of FIG. 4A.

### DETAILED DESCRIPTION OF THE PREFERRED EMBODIMENTS

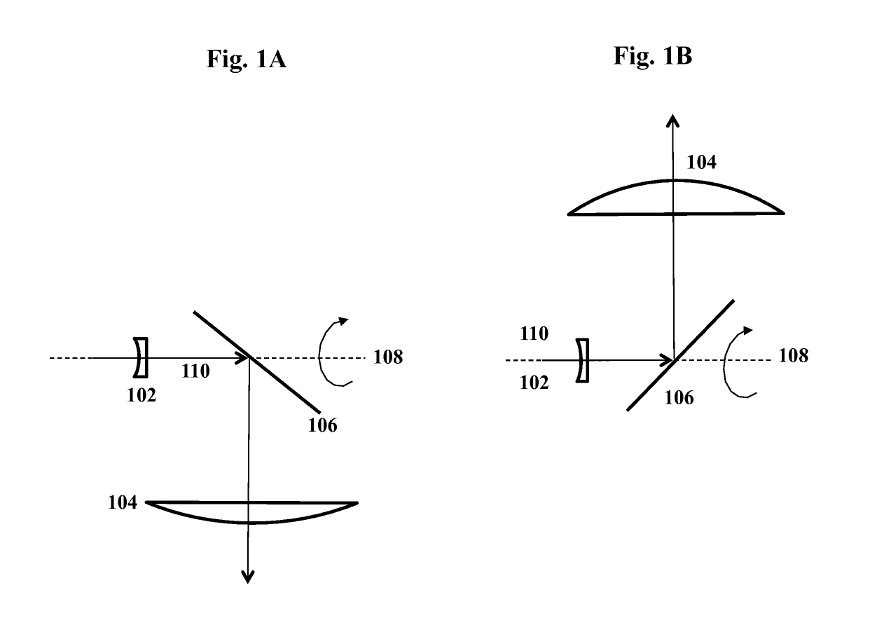

Turning in detail to the drawings, FIG. 1A illustrates the basic optical elements of abeam director, namely a first refractive element 102 and a second refractive element 104, both of which are optically coupled to each other through a reflective surface 106. The first refractive element 102 has an optical axis 108, around which the second refractive element 104 and the reflective surface 106 rotate together. In order to facilitate rotation, the second refractive element 104 may be mechanically coupled to the reflective surface 106.

This arrangement and coupling of the three optical elements can be used to adjust the direction of a beam 110 passed through the first refractive element 102, and there are two potential ways that the beam 110 may be steered. One way is to keep the first refractive element 102 stationary while the second refractive element 104 and the reflective surface 106 rotate together around the optical axis 108 of the first refractive element 102. The other way is to rotate all three optical elements (i.e., the first refractive element 102, the second refractive element 104, and the reflective surface 106) around the optical axis 108 of the first refractive element 102.

As is shown in FIG. 1A, the beam 110 is aimed down. FIG. 1B shows the same arrangement with the reflective surface 106 and second refractive element 104 rotated 180 degrees around the optical axis 108 of the first refractive element 102 to aim the beam up The first refractive element 102 may remain stationary, or the first refractive element 102 may be simultaneously rotated around its optical axis 108 with the other two elements the second refractive element 104 and the reflective surface 106. A rotation of 90 degrees from position shown in FIG. 1A would aim the beam 110 in a direction perpendicular of the plane of the drawing. Any degree of rotation of the optical elements is possible.

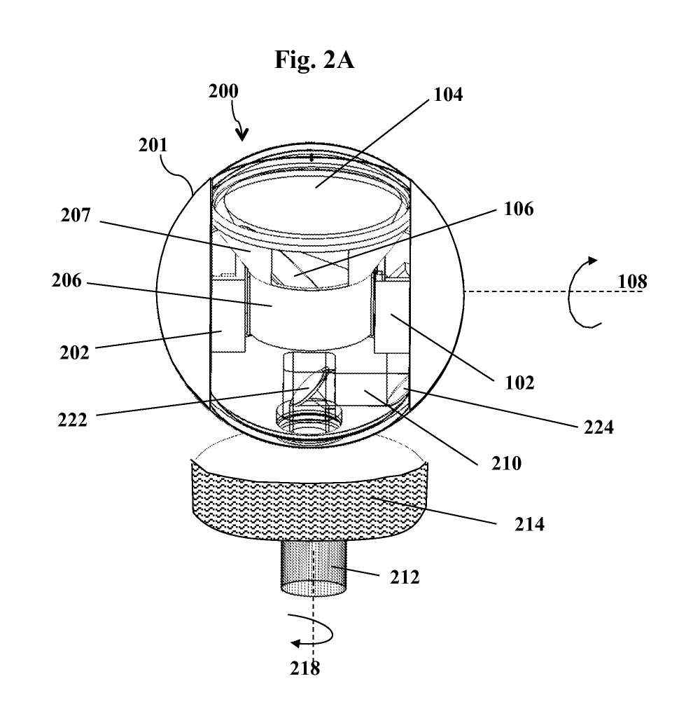

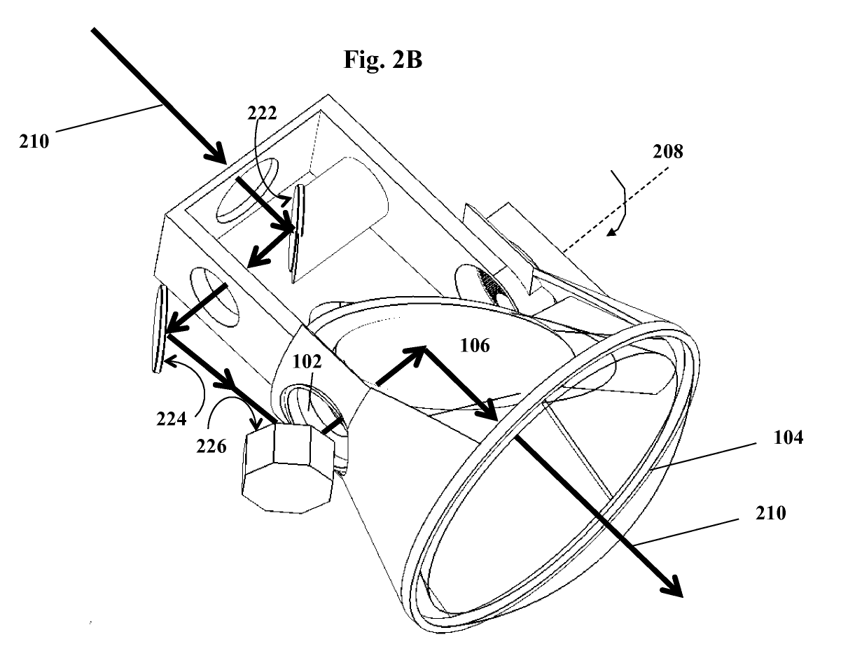

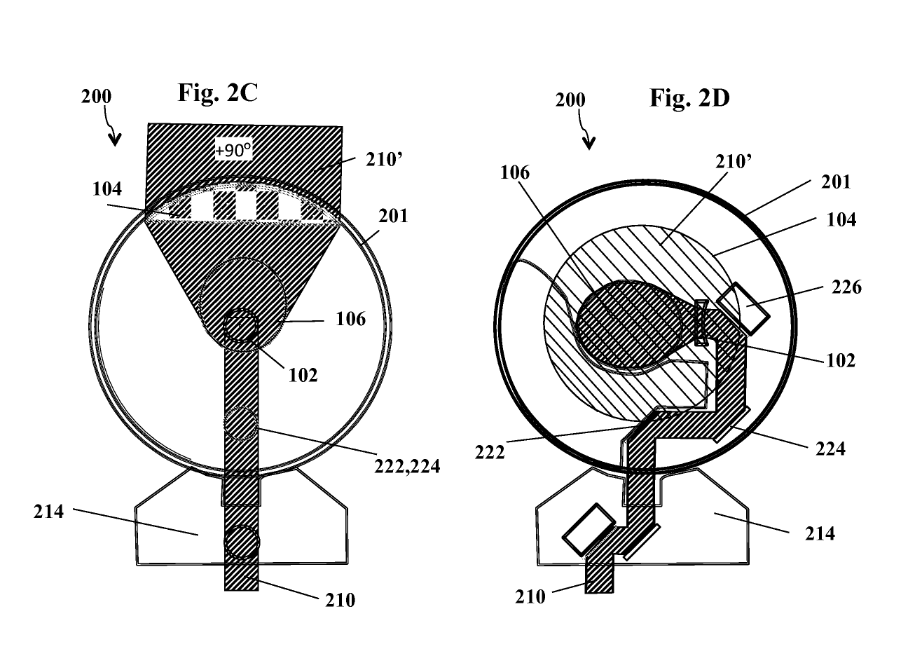

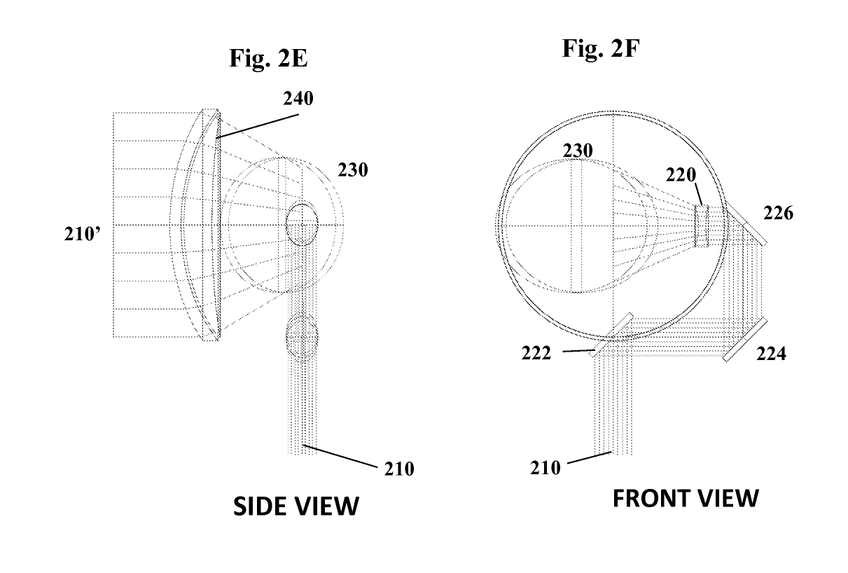

FIG. 2A illustrates a beam director 200 having two refractive elements 102, 104 and a reflective surface 106 enclosed within a housing 201. As described above, the first refractive element 102 is optically coupled to the second refractive element 104 through the reflective surface 106. The housing 201 includes a transmissive window 202 adjacent the second refractive element 104. The second refractive element 104 and the reflective surface 106 are mechanically coupled to a rotatable platform 206 which is set to rotate around the optical axis 108 of the first refractive element 102. The platform forms an enclosure 207 around the reflective surface 106, while the second refractive element 104 forms a window in the enclosure 207. The first refractive element 102 also forms a window in the enclosure 207. Thus, when the platform 206 rotates, all three of the first and second refractive elements 102, 104 and the reflective surface 106 are rotated around the optical axis 108 of the first refractive element 102. The mechanism for rotating the platform 206 around the optical axis 108 may include motors, ball bearings or air bearings, none of which are shown. The rotation around the optical axis 108 of the first refractive element 102 provides elevation angle adjustment for the beam director 200.

The transmissive window 202 may be approximately the same diameter as the second refractive element 104 if the housing itself rotates around the optical axis 108 of the first refractive element 102. For configurations in which the housing does not rotate about the optical axis 108 of the first refractive element 102, the size of the transmissive window 202 should be such that it allows for a full range of elevation aiming, to the extent the elevation aiming is not otherwise blocked by other parts of the beam director.

The housing 201 of the beam director 200 is mechanically coupled to another rotatable platform 214, which is set to rotate around a second axis 218. This second axis 218 is substantially perpendicular to the optical axis 108 of the first refractive element 102 and to the bottom surface of the housing 201; hence the two rotation axes 108 and 218 are substantially orthogonal to each other. The mechanism for rotating this second platform 214 around the axis 218 may similarly include motors, ball bearings or air bearings. The rotation around the axis 218 provides azimuth adjustment for the beam director 200.

An optical conduit is included to pass a beam 210 through the platform 214 and through the housing 201. The beam 210 is directed to the first refractive element 102 by one or more reflective surfaces 222, 224. Other optical elements may also be included to direct the beam the first refractive element, with the understanding that the more optical elements included in the housing, the less compact the beam director will be. The beam 210 is refracted by the first refractive element 102, reflects from the reflective surface 106, and is then refracted by the second refractive element 204. The beam 210 is then transmitted through the transmissive window 202 of the housing 201. The elevation direction of the beam 210 may be adjusted by rotating the first platform 206 around the axis 108, while the azimuth direction of the beam 210 may be adjusted by rotating the second platform 214, thereby also rotating the housing 201 and the first platform 206, around the axis 218.

FIG. 2B illustrates the optical path of the beam 210 and the optical components of the beam director 200 in greater detail. The beam 210 is routed to the first refractive element 102 by use of reflective surfaces 222, 224, 226. Once through the first refractive element 102, the beam 210 is then reflected by the reflective surface 106 toward and through the second refractive element 104.

FIG. 2C illustrates the side view of a solid beam path through the beam director 200 as seen looking along the optical axis 108 of the first refractive element 102. The beam emerges from the second refractive element 104 as an expanded beam 210′ with an increased diameter. The elevation position of the beam 210′ is shown at +90°. A ray trace of the beam 210 from this same side view is shown in FIG. 2E, except that the elevation position of the beam 210′ is shown at 0°. For the configuration of the beam director of FIG. 2A, the operational elevation range is expected to be between approximately −30° to +210°.

The amount of expansion of the beam resulting from the first and second refractive elements 102, 104 determines the minimum diameter needed for the housing. For example, if an expanded beam 210′ measures 12 inches in diameter, then the housing 201 should have a minimum internal diameter of approximately 18 inches. The overall housing height of the housing is not quite as dependent upon the expansion of the beam. By way of example, if an expanded beam 210′ measures 12 inches in diameter, then the height of the housing might be approximately 25 inches.

FIG. 2D illustrates the front view of a solid beam path through the beam director 200. In this view the expanded beam 210′ is aimed out of the plane of the drawing. A ray trace of the beam 210 from this same front view is shown in FIG. 2F.

A beam director using the same arrangement of a first refractive element, a reflective surface and a second refractive element, as described above, may be constructed in a variety of ways. Certain embodiments may involve the use of a dome shaped housing, and different configurations of the dome-shaped housing may have different limitations and advantages. For example, if the transmissive window in a dome-shaped housing spans approximately 170 degrees (starting from the base) in the elevation direction around the elevation axis and approximately 80 degrees in the azimuth direction around the azimuth axis, continuous overhead tracking would not be possible without engaging the azimuth adjustment. On the other hand, if the transmissive section of the dome-shaped housing spans approximately 280 degrees the elevation direction and approximately 80 degrees in the azimuth direction, continuous overhead tracking would be possible without engaging the azimuth adjustment provided that the rotation mechanism around the elevation axis allows for this motion. In either case, the use of the tube at the bottom that extends into the sphere of the dome-shaped housing precludes the complete sealing of the dome-shaped housing at its bottom. A beam director with a completely sealed housing may be useful in certain applications, such as applications that require submerging of the beam director under water. A beam director with a completely sealed housing and a transmissive bottom side could be constructed without a mechanical tube that extends into the housing structure. Instead the beam would transmit into the housing through its transmissive bottom.

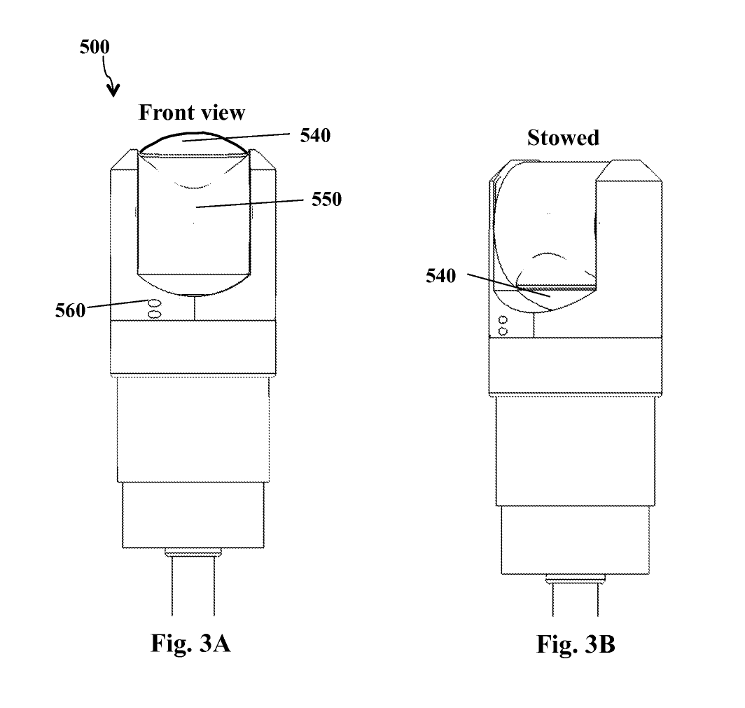

Two views of another embodiment 500 of the beam director are illustrated in FIG. 3A-B. The platform 550 of this beam director 500 encloses the reflective surface, and may enclose the first refractive element. and the second refractive element 540 forms a window in the enclosure of the platform 550.

FIG. 3A shows front view of the beam director 500 when with the platform 550 in the deployed position, so that the beam is aimed directly overhead. FIG. 3B shows the beam director 500 with the platform 550 in the stowed position. This beam director 500 may be preferred in certain applications where there is a requirement to maintain high wavefront quality for the beam, since a dome-shaped housing can often distort the wavefront of a beam passing through it. Moreover, domes often introduce reflections, which are highly undesirable, especially for high energy laser (HEL) beams.

The beam director 500 may be built to have an all metal platform 550 and an all metal housing 560. This all metal construction can maximize strength and minimize the optical transmission area. Another advantageous feature of the beam director 500 is continuous overhead tracking. Yet advantageous another feature of the embodiment 500 is the ease of stowing by simply rotating the platform 550 into the stowed as shown in FIG. 3B. When in the stowed position, the refractive element 540 is in the down position and can be protected by a retractable cover (not shown). The stowed position also facilitates the cleaning of the outward facing surface of the rotating refractive element which is exposed to the external environment.

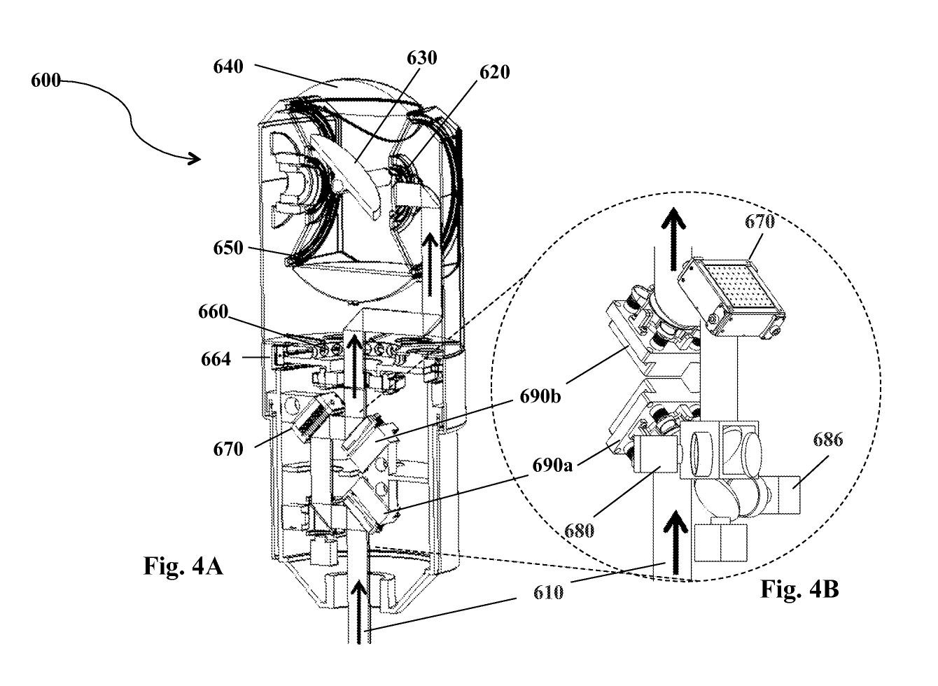

Besides the two refractive elements and the reflective surface, the beam director may include additional components for actuation towards azimuth and elevation adjustment, for wavefront correction, and for fast beam steering. The cross-section of another beam director 600, which includes such additional components, is shown in FIG. 4A. This beam director 600 includes the first refractive element 620, the reflecting surface 630, and the second refractive element 640, all as discussed above. The rotation mechanism for rotating the platform, and making elevation adjustment, includes air bearings 650 which can be coupled to an elevation drive motor (not shown). The rotation mechanism for rotating the housing, and making azimuth adjustment, also includes air bearings 660 which can be coupled to an azimuth drive motor (not shown). Both air bearings 650, 660 are able to provide near zero friction for ultrafast positioning and low wobble for accurate pointing maintenance. It may be preferable that all air bearings are manufactured as continuous circular surfaces with one side in contact with the interior volume and the other side in contact with the external environment. This configuration allows the air bearings to perform the function of a seal between the outside and inside environments. Due to the overpressure in the air bearings, this type of seal provides a continuous flow of gas through the tiny gap making it very difficult for dust, water or humid air to penetrate inside. Retracting seals 664 that fail safely into a sealed position can be used to take advantage of the low friction air bearings. Such retracting seals 664 open up when the air pressure is applied to the bearings and then retract back to a contact position when the air pressure is removed. A cavity and water intrusion pump can be used in marine environments to further isolate the interior from any potential splash and spray when the beam director 600 is elevated, deployed and the seals are retracted.

The beam director 600 may further include an adaptive optic system to correct the pointing and wavefront of the transmitted laser beam 610. This construction is appropriate for a high energy laser (HEL) beam director application to compensate for the aberrations that occur as the beam transmits to a remote target through a transmissive medium, e.g., the atmosphere.

As shown in FIG. 4B, which illustrates details of part of the optical path within the beam director 600 from another perspective, a target loop wavefront sensor 686 is included to measure the wavefront distortions that are induced by the transmission medium may be included in the beam path leading to the fast steering mirror 690a using an aperture sharing element that samples the beam all the way to a remote target. A target loop deformable mirror 670 may be included to compensate for these distortions registered by the target loop wavefront sensor.

A second wavefront sensor 680 may be included to measure the wavefront error from the laser source itself, which can be corrected by a second deformable mirror (not shown)or added to the first (target loop) deformable mirror 670 as a bias. Both configurations of adaptive optic system are well known to those skilled in the art of adaptive optics. A fast steering mirror 690b may be used to correct pointing jitter.

The target loop wavefront sensor and the end-to-end HEL tracking could use the HEL return from the target or from the atmosphere in clear and hazy conditions by referencing the HEL direction to a passive image of the target. Such a passive image could be in the midwave or shortwave infrared (MWIR or SWIR) band for day and night operation. This type of design eliminates the need for additional laser illuminators commonly used to provide a flood-lit target for tracking and a local source for wavefront measurements. A system and method for using HEL return for tracking and wavefront measurement is disclosed in U.S. Pat. No. 8,415,600, the disclosure of which is incorporated by reference in its entirety.

The beam director 600 shown in FIG. 4 may be embedded inside the mast of a submarine and submerged under water. In this application, not having any additional laser illuminators and using the return from the HEL source for beam control may provide a significant advantage since each laser source would require an addition mast to accommodate the additional beam director for that laser source. Another advantage offered by the beam director 600 is the tight water sealing of the air bearings with retractable seals.

The beam director can also be used to direct the field of view for any sensor array which is used to detect a laser return. Examples include two dimensional sensor arrays for conformal imaging and for the multi-beam laser phasing and aimpoint control systems, such as those disclosed in U.S. patent application Ser. No. 12/689,021, U.S. patent application Ser. No. 13/046,109, and U.S. patent application Ser. No. 13/476,380,

The beam director described above may present numerous advantages over the prior art. It may be used to aim a single beam or multiple beams that are entering or exiting its aperture in a desired direction or at an external or remote target. It may also significantly reduce the volume and weight required for a beam director of given aperture size. It may also provide smoother operation, thereby reducing jitter, especially at slower slew rates. The environmental seals provided by air bearings used in conjunction with the rotating parts may also be advantageous by allowing the beam director to operate in many harsh environments, e.g., high humidity, close to dirt, sand, and even submerged under water for long periods of time.

Thus, a more compact beam director is disclosed. While embodiments of these inventions have been shown and described, it will be apparent to those skilled in the art that many more modifications are possible without departing from the inventive concepts herein. The inventions, therefore, are not to be restricted except in the spirit of the following claims.

What is claimed is:

1. A beam director comprising:
a first refractive element having an optical axis;
a reflective surface;
a second refractive element optically coupled to the reflective surface and optically coupled to the first refractive element through the reflective surface; and;
a platform configured to rotate the reflective surface and the second refractive element around the optical axis while maintaining the optical couplings.

2. The beam director of claim 1, wherein the first refractive element is a first lens, the second refractive element is a second lens, and the reflective surface is a flat mirror.

3. The beam director of claim 1, wherein the first refractive element and the second refractive element are configured to expand a diameter of a beam passing therethrough, and the reflective surface is configured to fold an optical path of the beam.

4. The beam director of claim 1, wherein the platform platform is configured to rotate using air bearings.

5. The beam director of claim 1, wherein the reflective surface is disposed within an enclosure formed by the platform.

6. The beam director of claim 5, wherein the second refractive element forms a window in the enclosure.

7. The beam director of claim 5, wherein the first refractive element forms a first window in the enclosure, and the second refractive element forms a second window in the enclosure.

8. The beam director of claim 5, further comprising a housing, the first and second refractive elements, the reflective surface, and the platform being disposed in the housing, and an optical conduit configured to direct a beam into or out of the housing.

9. The beam director of claim 8, wherein the housing is configured to rotate around an axis which is substantially perpendicular to the optical axis.

10. The beam director of claim 1, wherein the platform is configured to rotate the first refractive element around the optical axis.

11. A beam director comprising:
a first refractive element having an optical
a reflective surface;
a second refractive element optically and mechanically coupled to the reflective surface and optically coupled to the first refractive element through the reflective surface;
a first platform coupled to and forming an enclosure about the reflective surface, the first and second refractive elements forming first and second windows, respectively, in the enclosure, wherein the first platform is configured to rotate around the optical axis; and
a second platform configured to rotate the first platform around an axis which is substantially perpendicular to the optical axis.

12. The beam director of claim 11, further comprising a wavefront sensor and a deformable mirror, the wavefront sensor being configured to detect distortions in a wavefront of incident light incident and the deformable mirror being configured to shape a wavefront of an outgoing beam to compensate for the detected distortions.

13. The beam director of claim 12, wherein the light incident on the wavefront sensor is from the outgoing beam.

14. The beam director of claim 12, wherein the light incident on the wavefront sensor is from light returning from a target.

15. The beam director of claim 11, further comprising a housing, the platform being disposed in the housing, and an optical conduit configured to direct a beam into or out of the housing.
